(19) United States
(12) Patent Application Publication
(10) Pub. No.: US 2022/0330106 A1
(43) Pub. Date: Oct. 13, 2022

(54) ENHANCEMENTS FOR CONDITIONAL HANDOVER IN MULTI-CONNECTIVITY OPERATION

(71) Applicant: Nokia Technologies Oy, Espoo (FI)

(72) Inventors: Ahmad AWADA, Munich (DE); Ingo VIERING, Munich (DE); Krzysztof KORDYBACH, Wroclaw (PL); Tero HENTTONEN, Wroclaw (PL); Srinivasa SELVAGANAPATHY, Bangalore (IN); Jedrzej STANCZAK, Wroclaw (PL)

(21) Appl. No.: 17/754,286

(22) PCT Filed: Sep. 24, 2020
(86) PCT No.: PCT/IB2020/058940

§ 371 Date: Mar. 29, 2022

(30) Foreign Application Priority Data
Oct. 4, 2019 (IN) 201941040225

(51) Int. Cl. H04W 36/00; H04W 36/08

(52) U.S. Cl. CPC H04W 36/0069; H04W 36/08

(57) ABSTRACT

A method and apparatus may include receiving, by a master node involved in multi-connectivity, at least one indication from a user equipment upon or after at least one condition for conditional cell change is fulfilled that it has detached from at least one source PSCell of a secondary node. The method may further include transmitting, by the master node, at least one SgNB Release Request to the source Secondary Node such that the secondary node stops transmission and reception on the source PSCell and/or initiates data forwarding to the target SN or to the MN. The method may further include receiving, by the master node, at least one SgNB Release Request Acknowledge from the source Secondary Node. The method may further include forwarding, by the master node, user data to the target secondary node upon receiving an indication from the user equipment.

### CROSS-REFERENCE TO RELATED APPLICATION

This application claims the benefit of Indian Provisional Application No. 201941040225, filed Oct. 4, 2019. The entire content of the above-referenced application is hereby incorporated by reference.

### TECHNICAL FIELD

Various communication systems may benefit from improved conditional handover procedures.

### BACKGROUND

3rd Generation Partnership Project (3GPP) radio access network (RAN)2 #107 included support for conditional new radio (NR) primary secondary cell (PSCell) additions or changes for both intra-secondary node (SN) and inter-SN cases. This may include changes to new PSCells controlled by the same SN and inter-SN, for example, changes to a new PSCell controlled by different SNs. It was agreed that conditional NR PSCell addition/change functionality would be supported, as well as providing development of conditional handover (CHO) solutions.

### SUMMARY

In accordance with some embodiments, a method may include receiving, by a master node involved in multi-connectivity, at least one indication from a user equipment upon or after at least one condition for conditional cell change is fulfilled that it has detached from at least one source primary secondary cell (PSCell) of a source secondary node.

In accordance with certain embodiments, an apparatus may include means for receiving at least one indication from a user equipment upon or after at least one condition for conditional cell change is fulfilled that it has detached from at least one source primary secondary cell (PSCell) of a source secondary node.

In accordance with various embodiments, an apparatus may include at least one processor and at least one memory including computer program code. The at least one memory and the computer program code may be configured to, with the at least one processor, cause the apparatus to at least receive at least one indication from a user equipment upon or after at least one condition for conditional cell change is fulfilled that it has detached from at least one source primary secondary cell (PSCell) of a source secondary node.

In accordance with some embodiments, a non-transitory computer readable medium may be encoded with instructions that may, when executed in hardware, perform a method. The method may include receiving at least one indication from a user equipment upon or after at least one condition for conditional cell change is fulfilled that it has detached from at least one source primary secondary cell (PSCell) of a source secondary node.

In accordance with certain embodiments, a computer program product may perform a method. The method may include receiving at least one indication from a user equipment upon or after at least one condition for conditional cell change is fulfilled that it has detached from at least one source primary secondary cell (PSCell) of a source secondary node.

In accordance with various embodiments, an apparatus may include circuitry configured to receive at least one indication from a user equipment upon or after at least one condition for conditional cell change is fulfilled that it has detached from at least one source primary secondary cell (PSCell) of a source secondary node.

In accordance with some embodiments, a method may include transmitting, by a user equipment involved in multi-connectivity, at least one indication to a master node upon or after at least one condition for CHO is fulfilled that it has detached from the source PSCell of a secondary node.

In accordance with certain embodiments, an apparatus may include means for transmitting at least one indication to a master node upon or after at least one condition for CHO is fulfilled that it has detached from the source PSCell of a secondary node.

In accordance with various embodiments, an apparatus may include at least one processor and at least one memory including computer program code. The at least one memory and the computer program code may be configured to, with the at least one processor, cause the apparatus to at least transmit at least one indication to a master node upon or after at least one condition for CHO is fulfilled that it has detached from the source PSCell of a secondary node.

In accordance with some embodiments, a non-transitory computer readable medium may be encoded with instructions that may, when executed in hardware, perform a method. The method may include transmitting at least one indication to a master node upon or after at least one condition for CHO is fulfilled that it has detached from the source PSCell of a secondary node.

In accordance with certain embodiments, a computer program product may perform a method. The method may include transmitting at least one indication to a master node upon or after at least one condition for CHO is fulfilled that it has detached from the source PSCell of a secondary node.

In accordance with certain embodiments, a computer program product may perform a method. The method may include transmitting at least one indication to a master node upon or after at least one condition for CHO is fulfilled that it has detached from the source PSCell of a secondary node.

### BRIEF DESCRIPTION OF THE DRAWINGS

For proper understanding of this disclosure, reference should be made to the accompanying drawings, wherein:

FIG. 1A illustrates an example of a signaling diagram for conditional handover.

FIG. 1B illustrates the continuation of the example signaling diagram of FIG. 1A.

FIG. 2 illustrates an example of another signaling diagram for SN modification—master node (MN) initiated procedure in Evolved-Universal Terrestrial Radio Access New Radio Dual Connectivity (EN-DC).

FIG. 3 illustrates an example of another signalling diagram for SN Modification—SN initiated procedure in EN-DC.

FIG. 4 illustrates an example of another signalling diagram for SN Modification—SN initiated procedure without master node (MN) involvement.

FIG. 5 illustrates an example of another signalling diagram for SN Change—MN initiated procedure in EN-DC.

FIG. 6 illustrates an example of another signalling diagram for SN Change—SN initiated procedure in EN-DC.

FIG. 7A illustrates an example of another signalling diagram for MN-initiated inter-SN PSCell change using CHO according to some embodiments.

FIG. 7B illustrates the continuation of the example signaling diagram of FIG. 7A, according to some embodiments.

FIG. 8A illustrates an example of another signalling diagram for on time forwarding and release of source PSCells using a UE indication to MN according to certain embodiments.

FIG. 8B illustrates the continuation of the example signaling diagram of FIG. 8A, according to certain embodiments.

FIG. 9A illustrates an example of another signalling diagram for early release of prepared target PSCells based on updated measurements at the time of CHO execution according to certain embodiments.

FIG. 9B illustrates the continuation of the example signaling diagram of FIG. 9A, according to certain embodiments.

FIG. 10A illustrates an example of another signalling diagram for early release of contention free random access resources in target PSCells based on UE indications sent to a MN according to certain embodiments.

FIG. 10B illustrates the continuation of the example signaling diagram of FIG. 10A, according to certain embodiments.

FIG. 11 illustrates an example of a flow diagram of a method that may be performed by a source node according to certain embodiments.

FIG. 12 illustrates an example of another flow diagram of a method that may be performed by a source node according to certain embodiments.

FIG. 13 illustrates an example of another flow diagram of a method that may be performed by a source node according to certain embodiments.

FIG. 14 illustrates an example of a system architecture according to certain embodiments.

### DETAILED DESCRIPTION

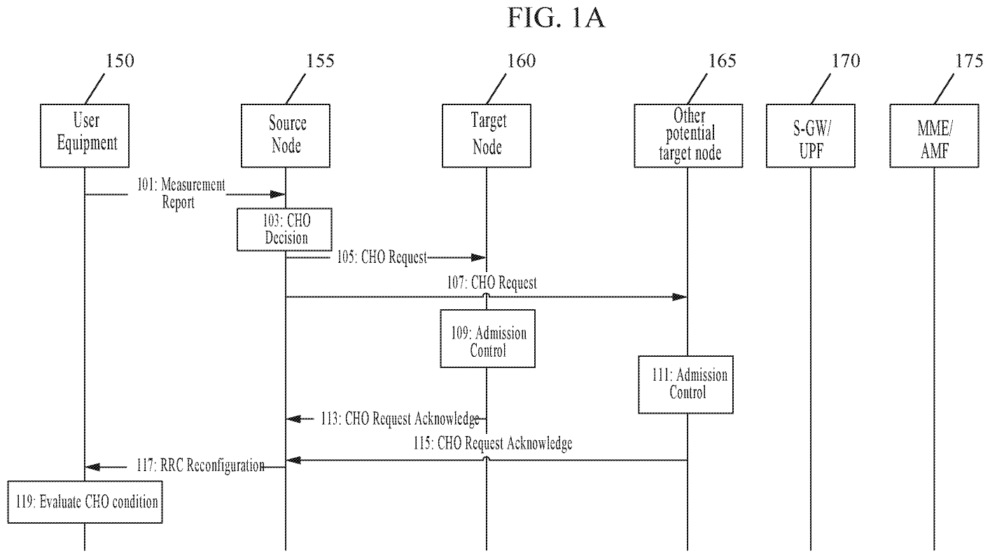

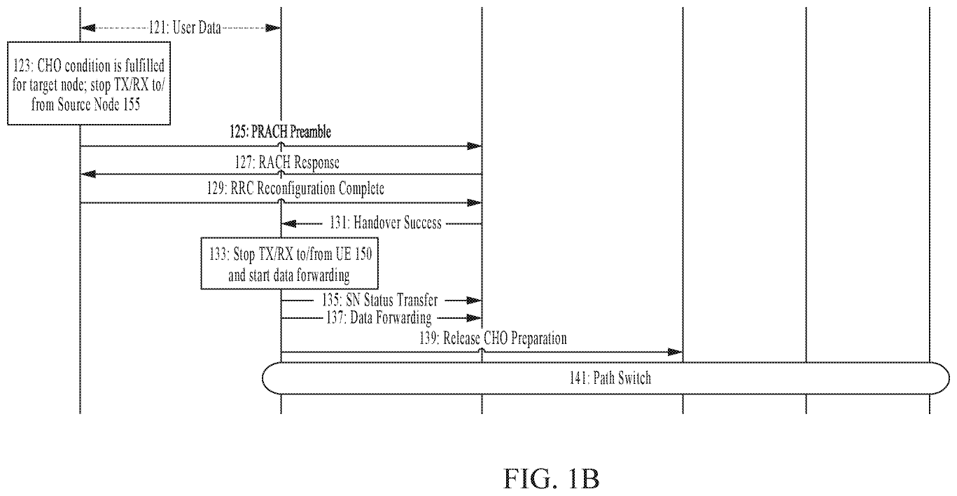

FIGS. 1A-1B illustrate an example of CHO, which may be similar to legacy handover procedures. Specifically, steps 101-117 may be similar to legacy handover where a configured event may trigger UE 150 to transmit a measurement report to source node 155 in step 101. Based upon this report, source node 155 may prepare at least one target node 160 for the handover, using CHO Requests 105 and 107 and CHO Request Acknowledgement 113 and 115, and then source node 155 may transmit at least one RRC Reconfiguration (HO command) to UE 150 in step 117.

For legacy HO, UE 150 may immediately access target node 160 to complete the handover. In contrast, for CHO, UE 150 may only access target node 160 once at least one additional CHO execution condition is fulfilled, such that the HO preparing and execution phases being are decoupled. The at least one additional condition may be configured by source node 155 in the HO Command message.

One advantage of CHO is that the HO command may be transmitted relatively early, while UE 150 is still secure with source node 155 without risking the access in target node 160, as well as the stability of its radio link; thus, CHO provides mobility robustness.

When source node 155 has prepared more than one target cell for CHO, late data forwarding may apply, as shown in step 137. Once UE 150 completes the handover execution to target node 160, such as where UE 150 has sent RRC Reconfiguration Complete in step 129, target node 160 may transmit to source node 155 in step 131 at least one indication of successful HO. Upon receiving this indication from target node 160, source node 155 may stop its transmitting to/receiving from UE 150, and initiate data forwarding to target node 160 in step 137. In addition, source node 155 may release the CHO preparations in other target nodes/cells which are no longer needed when source node 155 receives the indication of successful HO.

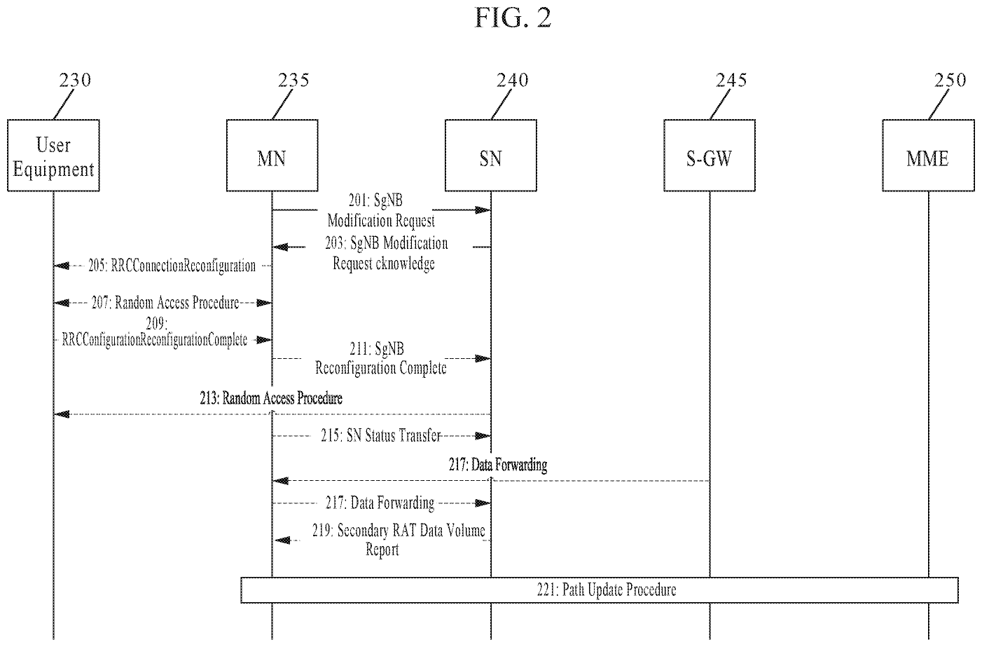

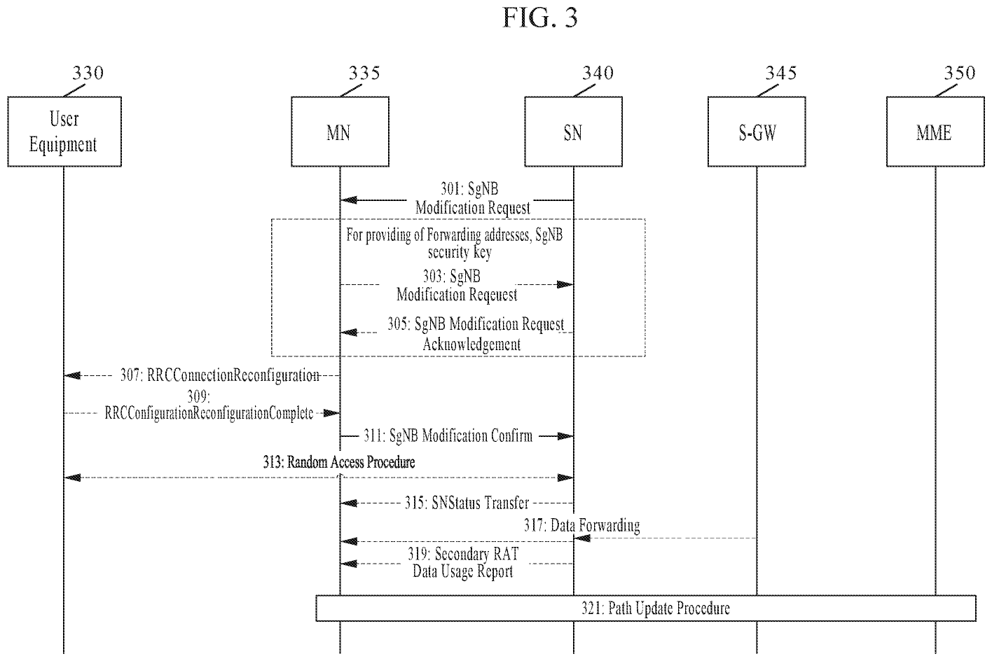

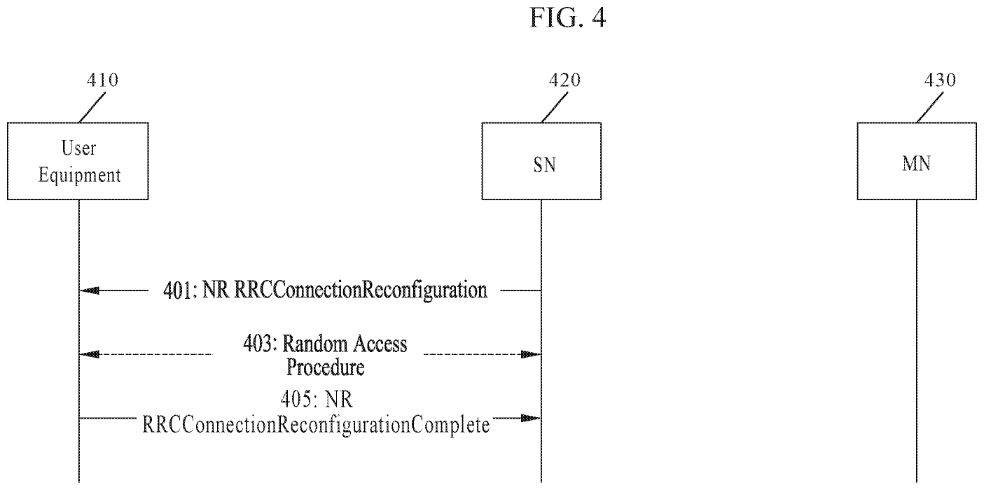

Intra-SN PSCell changes may be performed in NR using “Secondary Node Modification” procedures, such as described in 3GPP TS 37.340, Multi-connectivity, Stage 2 (Release 15), Section 10.4. For example, PSCell changes may be MN- or SN-initiated, with MN involvement, as illustrated in FIGS. 2 and 3 for E-UTRA-NR Dual Connectivity (EN-DC), respectively, or without MN involvement, as shown in FIG. 4.

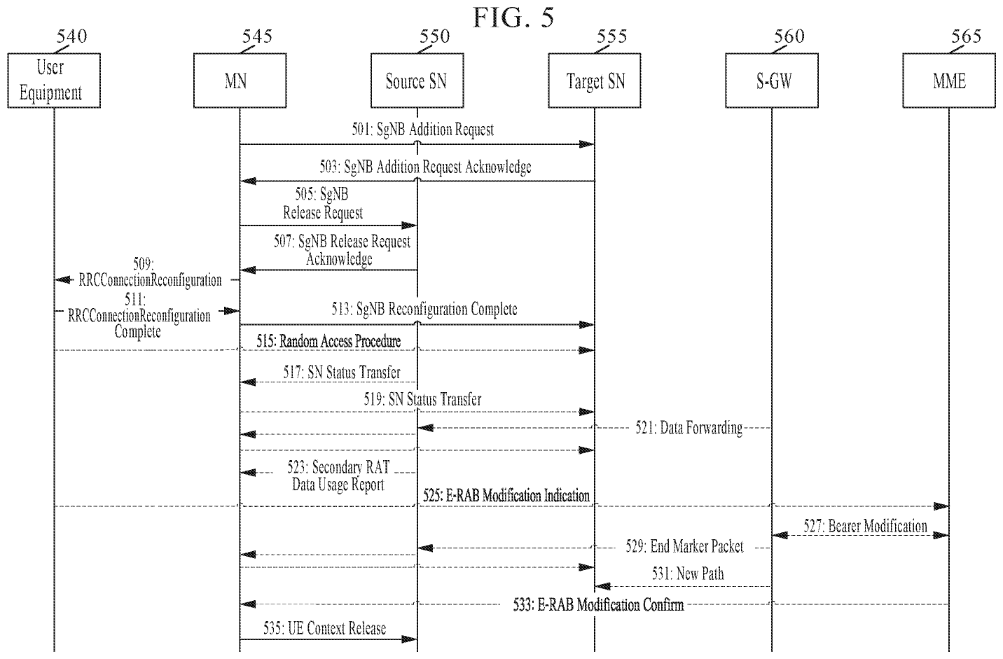

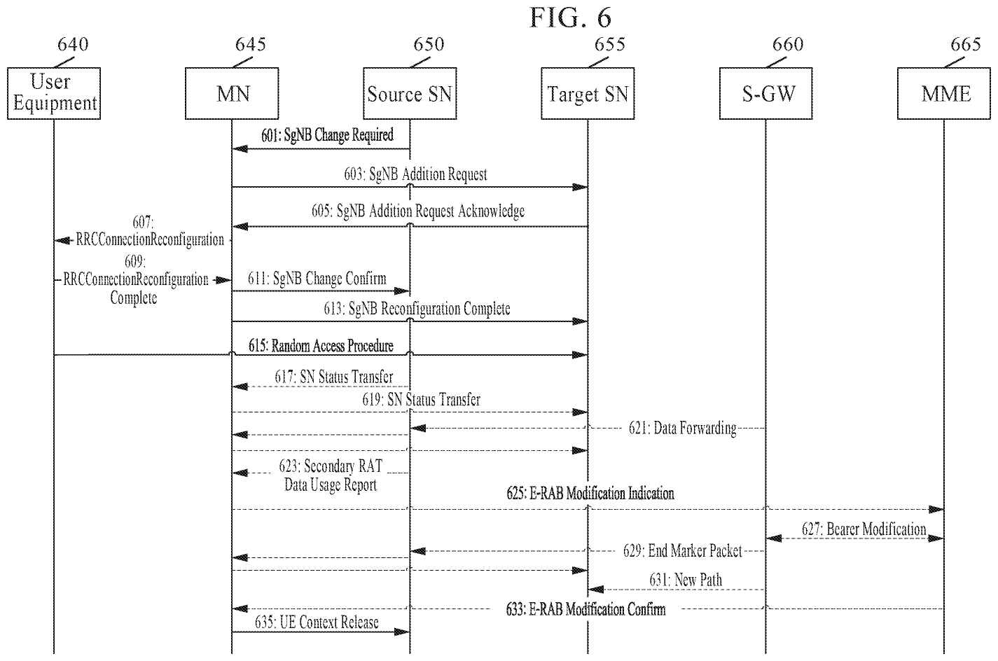

Inter-SN modifications may be performed in NR using “Secondary Node Change” procedures, described GPP TS 37.340, Multi-connectivity, Stage 2 (Release 15), Section 10.5. Similar to intra-SN scenarios, inter-SN changes may be MN- or SN-initiated, as illustrated in FIGS. 5 and 6 for EN-DC, respectively. Both FIGS. 5 and 6 demonstrate that the MN- and SN-initiated changes of SN are similar, with one difference being that the change procedures may be triggered by the SN in step 601 of FIG. 6.

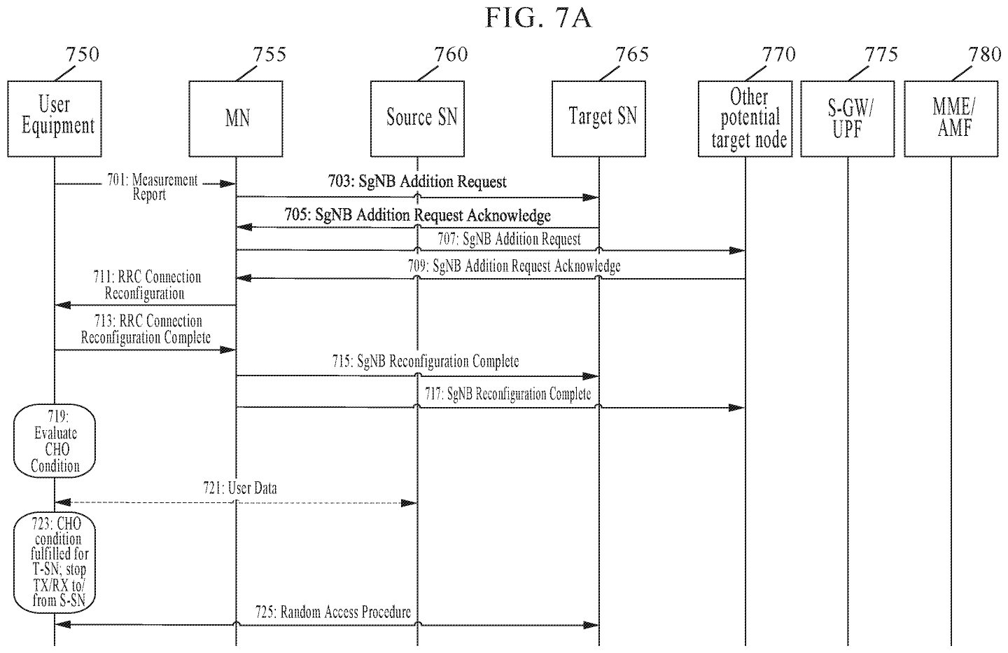

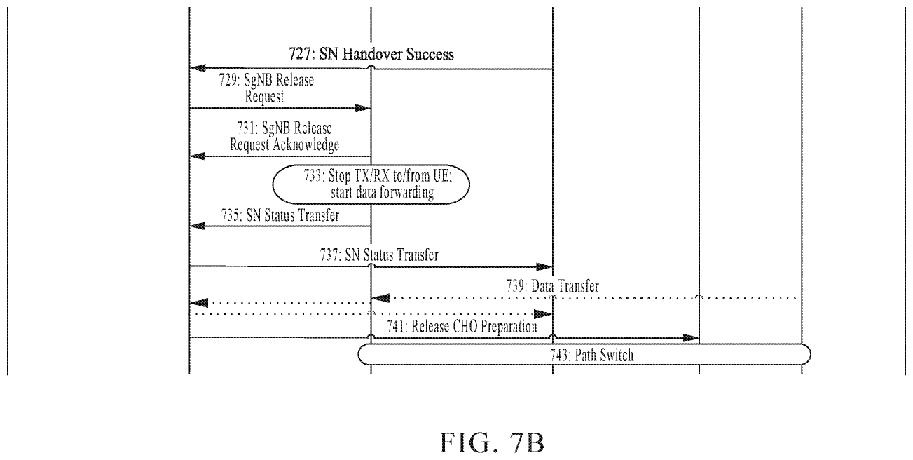

As noted above, FIGS. 7A-7B illustrate an example of a signaling diagram for MN-initiated inter-SN PSCell changes using CHO, wherein FIGS. 7A-7B combine the procedures of CHO shown in FIGS. 1A-1B through FIG. 5. For example, step 735 in FIG. 7B shows that SN 760 may transmit at least one sequence number status transfer indication to MN 755, which may be returned to target SN 765 in step 737.

FIGS. 7A-7B illustrate user data interruption due to late forwarding, similar to that shown in FIGS. 1A-1B in a single connectivity scenario. The downlink transmission from the new target SN may only begin after it has received the user data from the old SN. This is because after UE 750 has completed access in step 725, the new Target-SN 765 may need to transmit a first SN handover success message in step 727 to MN 755 to trigger the release of Source-SN 760, as well as begin data forwarding in step 739. This may result in an interruption for the bearers received using the secondary node radio link.

Furthermore, there may also be an unnecessary transmission of DL packets. For example, UE 750 may stop transmission/receiving with source SN 760 in step 723, but source SN 760 may only stop after step 729 when it receives the release request from MN 755. This uncertainty about when UE 750 detaches and performs access to target SN 765 may result in the unnecessary transmission of DL packets from source SN 760 to UE 750.

For the SN following the centralized unit (CU)-distributed unit (DU) architecture, the user data may need to be forwarded to the DU of the new target PSCell over an F1 interface if the source and target PSCells are controlled by different DUs. Furthermore, for intra-SN PSCell changes, the SN may stop the tx/rx on the source PSCell only when the UE successfully completes the RACH access/conditional execution to the new target PSCell when it may recognize the UE has being detached from the source PSCell.

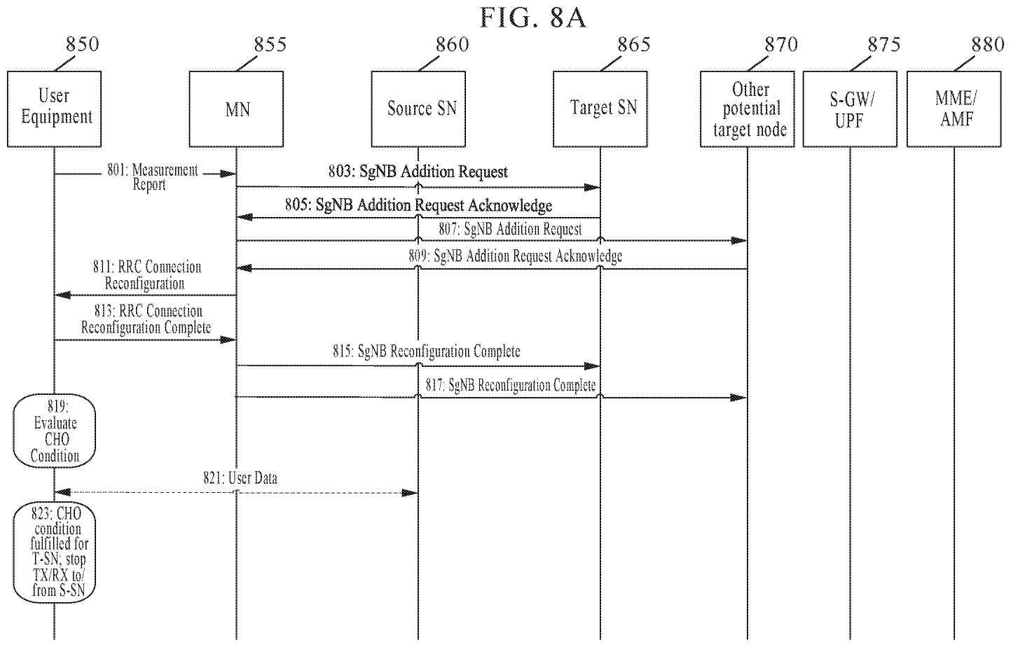

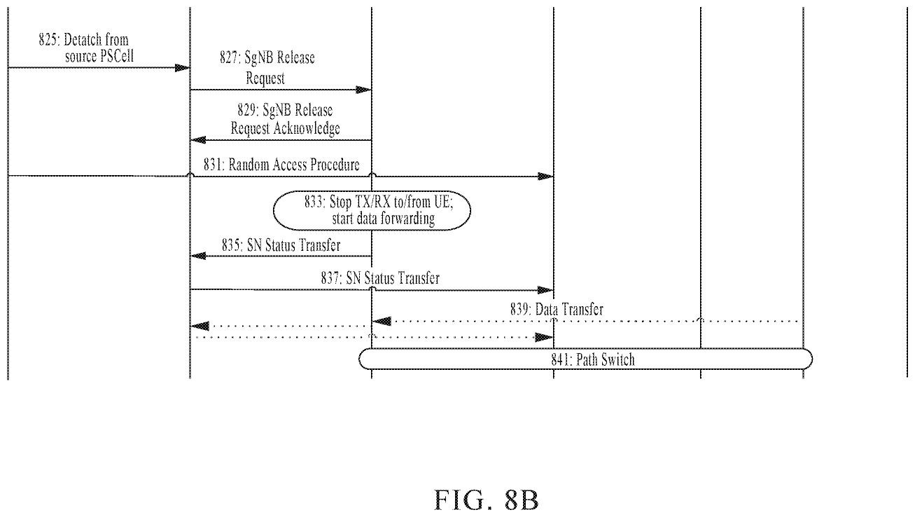

In order to address some of the disadvantages of the procedures discussed above, some embodiments described herein relate to a UE configured with conditional PSCell changes to transmit at least one indication message to the master node (MN) of multi-connectivity operation after or upon the CHO condition being fulfilled, as shown in FIGS. 8A-8B, and the UE detaching from the source PSCell controlled by the source SN. Upon receiving this indication from the UE, the MN may request the source SN (controlling source PSCell) to stop tx/rx with the UE, and/or to begin user data forwarding to the new target SN, such as directly to the target SN or via the MN, or from a CU if the source and target cells are controlled by different DUs of the same CU. In various embodiments, for example, during an inter-SN change, when termination point changes, SN-terminated at the source SN, but MN adds MN-terminated bearer to the target SN, the source SN may begin user data forwarding to the MN upon receiving the request from MN that is sent when the indication from the UE is received. In some embodiments, such as with inter-SN changes for a UE configured with MN-terminated bearers (or such as inter-SN change, when termination point changes; MN-terminated at the source SN, but MN adds SN-terminated bearer to the target SN), the MN may forward the packets directly to the target SN upon receiving the new indication from the UE.

Furthermore, additional information may be sent to the MN in the same message containing the indication, or in a separate message subsequent to the indication. For example, measurements associated with target PSCells may have been prepared excluding the one that the UE has selected first to access. Using these measurements, the MN or the source SN (when receiving the measurements from the MN) may release the conditional preparation for some of the prepared target PSCells which are no longer relevant for CHO, such as those which have the weakest radio link quality, while the UE is already accessing a new target PSCell. Releasing all target PSCells while the UE is performing conditional access to one target PSCell may not be useful since the conditional execution may fail, and a fallback to another prepared PSCell, while timer T304 supervising the HO/PSCell change execution is running, may help to complete the handover. Thus, it is expected that the MN or source SN would release some of the prepared target PSCells.

In addition, IDs of the prepared PSCells that the UE has tried but failed to access during CHO execution (while timer T304 supervising the HO executing is running) may also be sent to the MN in the same message containing the indication and/or in a separate message subsequent to the indication. Finally, at least one flag indicating to the network that contention-free random access (CFRA) may no longer be performed to some of the target PSCells may also be sent. For example, this flag may be sent when the UE detects that the signal strength/quality of SSBs/CSI-RS associated with CFRA resources for a prepared target PSCell are below at least one threshold. Using the at least one flag, the MN or source SN (when receiving the flags) may perform an early release of the CFRA resources at the target PSCells. Furthermore, for prepared target PSCells for which CFRA is still possible, the UE may indicate to the network the CFRA resource that may be released (those corresponding to weak SSBs/CSI-RSs measurements associated with CFRA resources) out of the whole set of CFRA resources.

The indication transmitted by the UE to the MN may be received reliably by the MN which is not the source cell for CHO, such as where it is the source PSCell link (controlled by SN) which deteriorates, while the MN is assumed to remain stable and the indication is sent towards the MN. The indication message may be transmitted when the CHO condition is fulfilled, not only when the access is completed; thus, it allows the source SN to stop tx/rx on the source PSCell and to begin data forwarding sooner.

Certain embodiments described herein may have various benefits and/or advantages to overcome the disadvantages described above. For example, a source PSCell may initiate data forwarding on time such that the downlink user data is available at the target PSCell when the UE completes the handover execution; thus, downlink interruption time may be reduced since the target cell may start immediately to schedule user data received from the source cell when the UE completes the handover execution. The source PSCell may stop on time its radio communication with the UE after or upon CHO condition is fulfilled. As a result, the source PSCell may stop transmitting any downlink and uplink grants or user data as soon as the UE detaches from the source PSCell.

In addition, the indication received by the MN upon or after the CHO condition is fulfilled may help the network to release prepared PSCells that are no longer useful for CHO procedure (PSCells having weak radio links or for which the UE has failed to access during random access procedure) and/or CFRA resources associated with SSB blocks or CSI-RS that can no longer be used (having weak signals). Thus, certain embodiments are directed to improvements in computer-related technology.

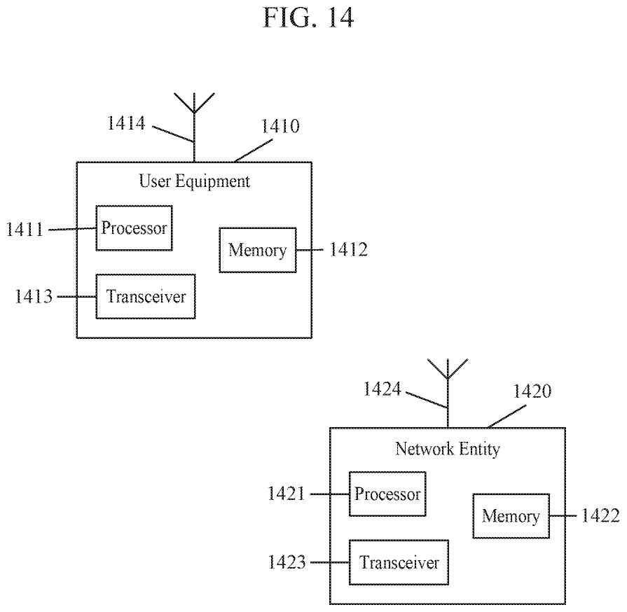

FIGS. 8A-8B illustrate an example of a signaling diagram where MN 855 receives from UE 850 at least one indication 825 that it has detached from a source PSCell controlled by source S-SN 860. After receiving the at least one indication 825, MN 855 may request source SN 860 to stop tx/rx on source PSCell with UE 850, as well as to start user data forwarding to target SN 865 controlling a new PSCell. UE 850 may be similar to UE 1410, and MN 855, source SN 860, target SN 865, other potential target nodes 870, S-GW UPF 875, and/or MME/AMF 880 may be similar to NE 1420, both illustrated in FIG. 14.

In step 801, UE 850 may transmit at least one measurement report to MN 855. In step 803, MN 855 may transmit at least one SgNB Addition Request to target SN 865. In step 805, target SN 865 may transmit at least one SgNB Addition Request Acknowledgement to MN 855. In step 807, MN 855 may transmit at least one SgNB Addition Request to at least one other potential target node 870. In step 809, at least one other potential target node 870 may transmit at least one SgNB Addition Request Acknowledgement to MN 855.

In step 811, MN 855 may transmit at least one RRCConnectionReconfiguration message to UE 850. In step 813, UE 850 may transmit at least one RRCConnectionReconfigurationComplete message to MN 855. In step 815, MN 855 may transmit at least one SgNB Reconfiguration Complete message to target SN 865. In step 817, MN 855 may transmit at least one SgNB Reconfiguration Complete message to at least one other potential target node 870. In step 819, UE 850 may evaluate at least one CHO Condition. In step 821, UE 850 and source SN 860 may exchange user data. In step 823, UE 850 may determine that at least one CHO condition has been fulfilled for target SN 865. In addition, UE 850 may stop transmitting/receiving with source SN 860.

In step 825, UE 850 may transmit at least one indication to MN 855. The at least one indication may indicate that UE 850 has detached from at least one source PSCell controlled by source SN 860. The at least one indication may be transmitted over at least one physical uplink control channel (PUCCH), at least one MAC CE, or at least one RRC message. Additionally or alternatively, the at least one indication may be transmitted to MN 855 before or after UE 850 transmits at least one PRACH preamble to the target PSCell, for example, after or before step 831, in order to avoid the disadvantages of late forwarding.

In step 827, MN 855 may transmit at least one SgNB Release Request to source SN 860. The at least one SgNB Release Request may request source SN 860 to stop tx/rx with one source PSCell of UE 850 and to start user data forwarding to target SN 865 controlling at least one new PSCell. As a result, subsequent steps 827, 829, 833, 835, 837, and 839 may be performed in parallel with step 831 where UE 850 is synchronizing and performing at least one random access procedure with at least one PSCell of target SN 865.

In step 829, source SN 860 may transmit at least one SgNB Release Request Acknowledgement to MN 855. In step 831, UE 850 may perform at least one random access procedure with target SN 865. In some embodiments, the random access procedure may comprise at least the UE 850 sending PRACH preamble to the target PSCell and receiving RACH response from the target PSCell. In step 833, source SN 860 may stop transmitting/receiving with UE 850. In addition, source SN 860 may start data forwarding. In step 835, source SN 860 may transmit at least one sequence number Status Transfer indication to MN 855.

In step 837, MN 855 may transmit the at least one sequence number status transfer indication to target SN 865. In step 839, the S-GW/UPF 875 may transfer data to source SN node 860, which may further transfer data to MN 855, which may further transfer to target SN 865. In step 841, source SN 860, target SN 865, and/or S-GW/UPF 875 may be associated with at least one path switch.

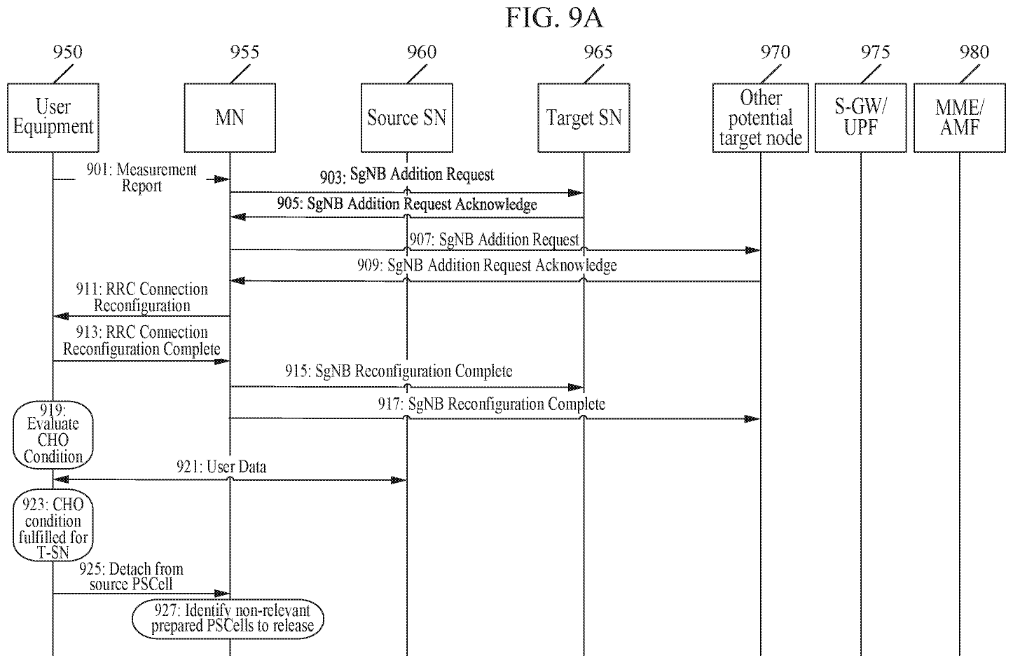

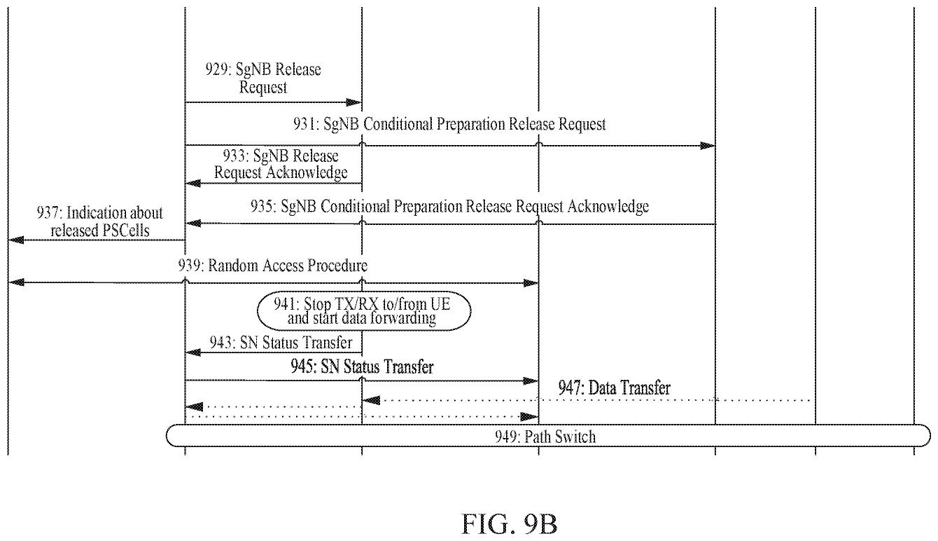

FIGS. 9A-9B illustrate an example of a signaling diagram. UE 950 may be similar to UE 1410, and MN 955, source SN 960, target SN 965, other potential target nodes 970, S-GW UPF 975, and MME/AMF 980 may be similar to NE 1420, both illustrated in FIG. 14.

In step 901, UE 950 may transmit at least one measurement report to MN 955. In step 903, MN 955 may transmit at least one SgNB Addition Request to target SN 965. In step 905, target SN 965 may transmit at least one SgNB Addition Request Acknowledgement to MN 955. In step 907, MN 955 may transmit at least one SgNB Addition Request to at least one other potential target node 970. In step 909, the at least one other potential target node 970 may transmit at least one SgNB Addition Request Acknowledgement to MN 955. In step 911, MN 955 may transmit at least one RRCConnectionReconfiguration message to UE 950. In step 913, UE 950 may transmit at least one RRCConnectionReconfigurationComplete message to MN 955.

In step 915, MN 955 may transmit at least one SgNB Reconfiguration Complete message to target SN 965. In step 917, MN 955 may transmit at least one SgNB Reconfiguration Complete message to the at least one other potential target node 970. In step 919, UE 950 may evaluate at least one CHO Condition. In step 921, UE 950 and source SN 960 may exchange user data. In step 923, UE 950 may determine that at least one CHO condition is fulfilled for target SN 965.

In step 925, UE 950 may transmit at least one indication to MN 955 to indicate that it has detached from at least one source PSCell of source SN 960. In some embodiments, the at least one indication may comprise at least one measurement associated with at least one prepared PSCell. Furthermore, the at least one measurement may be associated with cell-quality and/or beam measurements performed using SSBs or CSI-RS. In step 927, MN 955 may identify at least one non-relevant prepared PSCell to release. In certain embodiments, MN 955, using the at least one measurement, may determine that an early release of CHO preparation for at least one prepared PSCell should occur in step 931. In step 929, MN 955 may transmit at least one SgNB Release Request to source SN 960. In step 931, MN 955 may transmit at least one SgNB Conditional Preparation Release Request to at least one other potential target node 970. In step 933, source SN 960 may transmit at least one SgNB Release Request Acknowledge to MN 955. In step 935, at least one other potential target node 970 may transmit at least one SgNB Conditional preparation Release Request Acknowledge to MN 955.

In step 937, MN 955 may transmit information about at least one released PSCell to UE 950. For example, the information may indicate to UE 950 about the release of at least one released PSCell.

In step 939, UE 950 may initiate the random access procedure to target SN 965. During random access procedure 939, UE 950 may indicate to MN 955 using a signaling message that may be different than 925 that at least one physical or global cell identity of at least one target PSCell for which UE 950 failed to perform CHO execution, such as when at least one T304 timer is running. Upon receiving this information, MN 955 may transmit at least one request to release CHO preparation in the indicated at least one target PSCell and/or inform UE 950 of the released at least one PSCell, such as described in steps 931, 935, and 937.

In step 941, source SN 960 may stop transmitting/receiving with UE 950 and/or may begin data forwarding. In step 943, source SN 960 may transmit at least one sequence number Status Transfer to MN 955. In step 945, MN 955 may transmit the at least one sequence number Status Transfer to target SN 965.

In step 947, the S-GW/UPF 975 may transfer data to source SN node 960, which may further transfer data to MN 955, which may further transfer to target SN 965. In step 949, source SN 960, target SN 965, and/or S-GW/UPF 975 may be associated with at least one path switch.

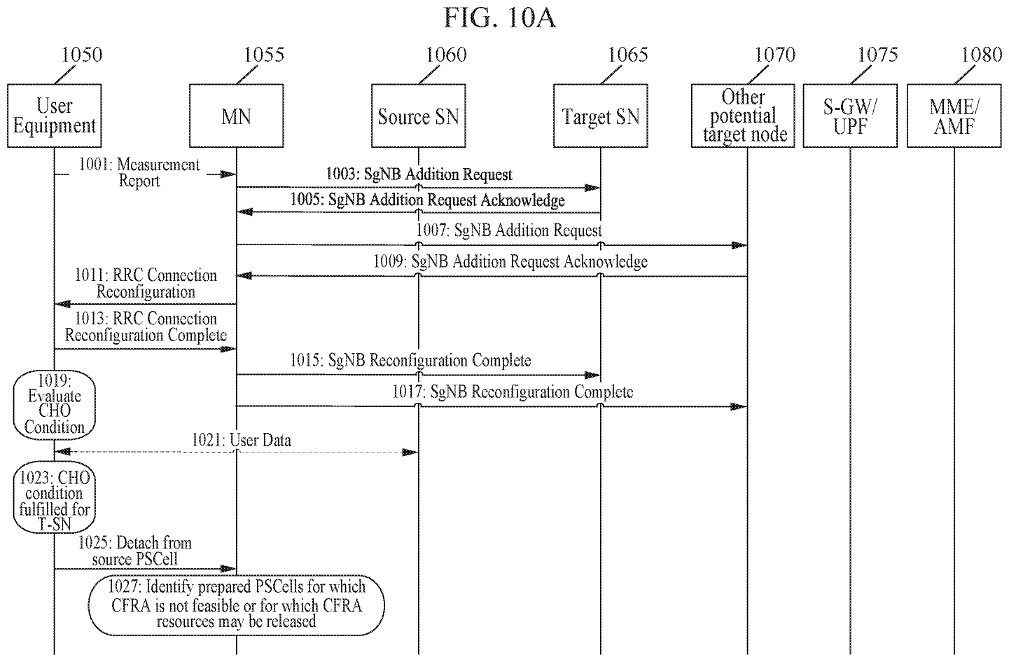

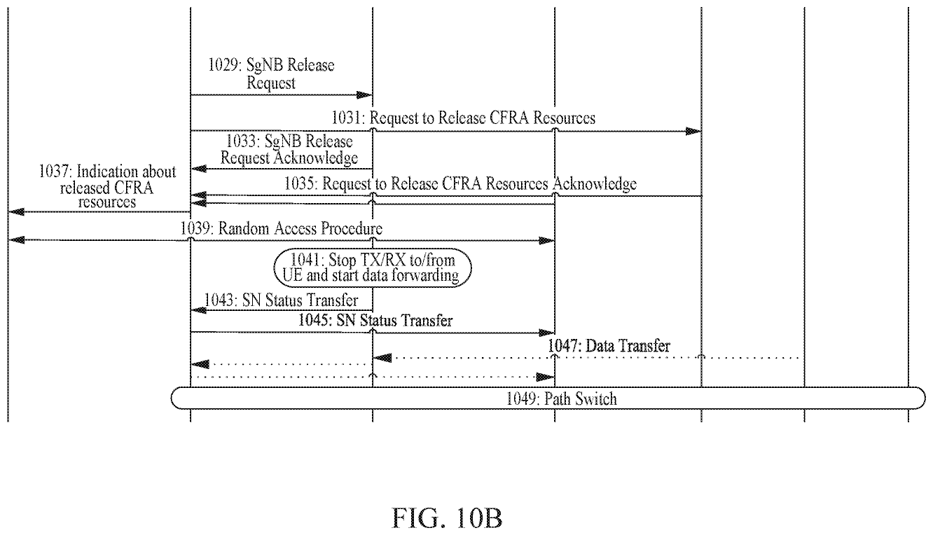

FIGS. 10A-10B illustrate an example of a signaling diagram. UE 1050 may be similar to UE 1410, and MN 1055, source SN 1060, target SN 1065, other potential target nodes 1070, S-GW UPF 1075, and MME/AMF 1080 may be similar to NE 1420, both illustrated in FIG. 14.

In step 1001, UE 1050 may transmit at least one measurement report to MN 1055. In step 1003, MN 1055 may transmit at least one SgNB Addition Request to target SN 1065. In step 1005, target SN 1065 may transmit at least one SgNB Addition Request Acknowledgement to MN 1055. In step 1007, MN 1055 may transmit at least one SgNB Addition Request to at least one other potential target node 1070. In step 1009, the at least one other potential target node 1070 may transmit at least one SgNB Addition Request Acknowledgement to MN 1055. In step 1011, MN 1055 may transmit at least one RRCConnectionReconfiguration message to UE 1050. In step 1013, UE 1050 may transmit at least one RRCConnectionReconfigurationComplete message to MN 1055. In step 1015, MN 1055 may transmit at least one SgNB Reconfiguration Complete message to target SN 1065. In step 1017, MN 1055 may transmit at least one SgNB Reconfiguration Complete message to the at least one other potential target node 1070. In step 1019, UE 1050 may evaluate at least one CHO Condition. In step 1021, UE 1050 and source SN 1060 may exchange user data. In step 1023, UE 1050 may determine that at least one CHO condition is fulfilled for target SN 1065.

In step 1025, UE 1050 may transmit at least one indication to MN 1055 to indicate that it has detached from at least one source PSCell of source SN 1060. In some embodiments, the at least one indication may comprise at least one flag configured to inform MN 1055 whether CFRA may be performed to a prepared PSCell and/or at least one CFRA resource which can be released when CFRA is still possible.

In step 1027, MN 1055 may identify at least one prepared PSCell for which CFRA is not feasible and/or for which at least one CFRA resource may be released. In certain embodiments, MN 1055 may request target SN 1065 and/or 1070 controlling the at least one prepared PSCell to release at least one indicated CFRA resource.

In some embodiments, CFRA related information may be transmitted when the CHO execution condition is fulfilled and/or when UE 1050 starts the CHO execution to the target PSCell in question.

In step 1029, MN 1055 may transmit at least one SgNB Release Request to source SN 1060. In step 1031, MN 1055 may transmit at least one Request to Release CFRA Resources to at least one other potential target node 1070. In step 1033, source SN 1060 may transmit at least one SgNB Release Request Acknowledge to MN 1055. In step 1035, the at least one other potential target node 1070 and/or target SN 1065 may transmit at least one Request to Release CFRA Resources Acknowledge to MN 1055. In step 1037, MN 1055 may transmit at least one indication about at least one released CFRA resource to UE 1050. In step 1039, UE 1050 performs the random access procedure to target SN 1065.

In step 1041, source SN 1060 may stop transmitting/receiving with UE 1050 and/or start data forwarding. In step 1043, source SN 1060 may transmit at least one sequence number Status Transfer indication to MN 1055. In step 1045, MN 1055 may transmit the at least one sequence number Status Transfer to target SN 1065.

In step 1047, the S-GW/UPF 1075 may transfer data to source SN node 1060, which may further transfer data to MN 1055, which may further transfer to target SN 1065. In step 1049, source SN 1060, target SN 1065, and/or S-GW/UPF 1075 may be associated with at least one path switch.

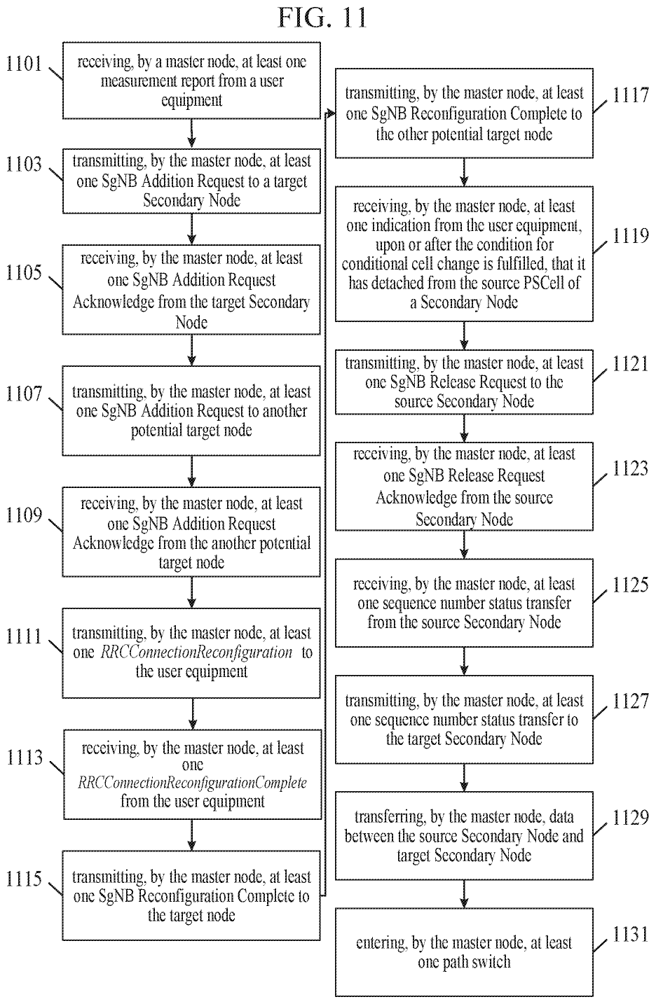

FIG. 11 illustrates an example of a method performed by a network entity (NE), such as network entity 1420 illustrated in FIG. 14, according to certain embodiments. In step 1101, the NE may receive at least one measurement report from a user equipment. In step 1103, the NE may transmit at least one SgNB Addition Request to a target Secondary Node. In step 1105, the NE may receive at least one SgNB Addition Request Acknowledge from the target Secondary Node. In step 1107, the NE may transmit at least one SgNB Addition Request to another potential target node. In step 1109, the NE may receive at least one SgNB Addition Request Acknowledge from the other potential target node. In step 1111, the NE may transmit at least one RRCConnectionReconfiguration to the user equipment. In step 1113, the NE may receive at least one RRCConnectionReconfigurationComplete from the user equipment. In step 1115, the NE may transmit at least one SgNB Reconfiguration Complete to the target node. In step 1117, the NE may transmit at least one SgNB Reconfiguration Complete to the other potential target node.

In step 1119, the NE may receive at least one indication from the user equipment, upon or after the condition for conditional cell change is fulfilled, that it has detached from the source PSCell of a Secondary Node. In step 1121, the NE may transmit at least one SgNB Release Request to the source Secondary Node. In step 1123, the NE may receive at least one SgNB Release Request Acknowledge from the source Secondary Node. In step 1125, the NE may receive at least one sequence number status transfer from the source Secondary Node. In step 1127, the NE may transmit at least one sequence number status transfer to the target Secondary Node. In step 1129, the NE may transfer data between the source Secondary Node and target Secondary Node. In step 1131, the NE may enter at least one path switch.

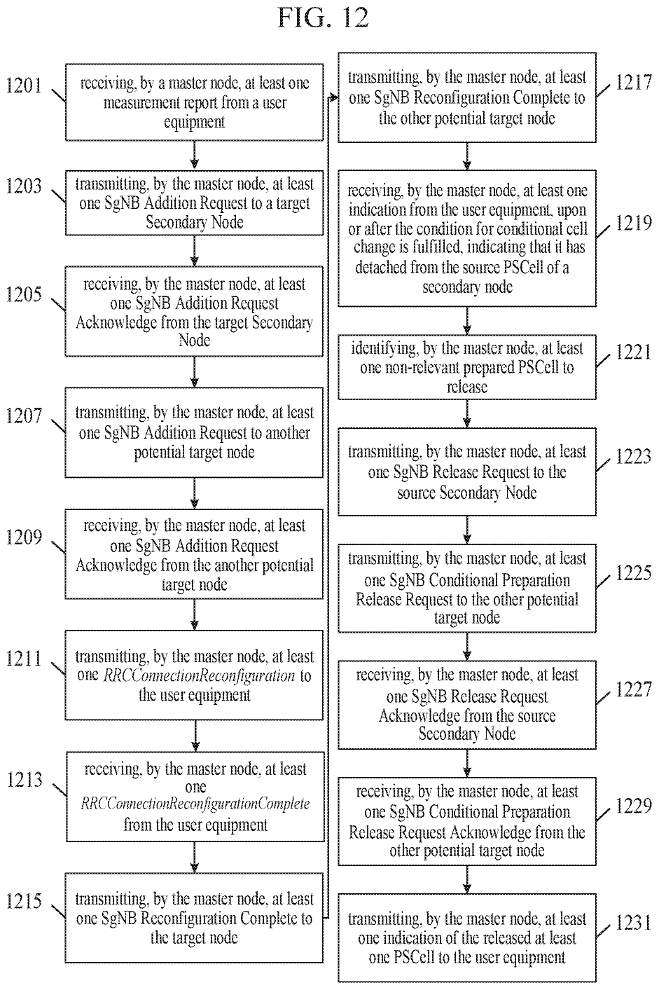

FIG. 12 illustrates an example of a method performed by a network entity, such as network entity 1420 illustrated in FIG. 14, according to certain embodiments. In step 1201, the NE may receive at least one measurement report from a user equipment. In step 1203, the NE may transmit at least one SgNB Addition Request to a target Secondary Node. In step 1205, the NE may receive at least one SgNB Addition Request Acknowledge from the target Secondary Node. In step 1207, the NE may transmit at least one SgNB Addition Request to another potential target node. In step 1209, the NE may receive at least one SgNB Addition Request Acknowledge from the other potential target node. In step 1211, the NE may transmit at least one RRCConnectionReconfiguration to the user equipment. In step 1213, the NE may receive at least one RRCConnectionReconfigurationComplete from the user equipment. In step 1215, the NE may transmit at least one SgNB Reconfiguration Complete to the target node. In step 1217, the NE may transmit at least one SgNB Reconfiguration Complete to the other potential target node. In step 1219, the NE may receive at least one indication from the user equipment, upon or after the condition for conditional cell change is fulfilled, indicating that it has detached from the source PSCell of a secondary node. The indication may further include updated cell and/or beam measurements for prepared PSCells.

In step 1221, the NE may identify at least one non-relevant prepared PSCell to release. In step 1223, the NE may transmit at least one SgNB Release Request to the source Secondary Node. In step 1225, the NE may transmit at least one SgNB Conditional Preparation Release Request to the other potential target node. In step 1227, the NE may receive at least one SgNB Release Request Acknowledge from the source Secondary Node. In step 1229, the NE may receive at least one SgNB Conditional Preparation Release Request Acknowledge from the other potential target node. In step 1231, the NE may transmit at least one indication of the released at least one PSCell to the user equipment. In some embodiments, after or during the random access procedure to the target PSCell, the UE may include at least one physical or global cell identity of the target PSCell for which it has failed to perform CHO execution, such as when timer T304 is running. Upon receiving the at least one physical or global cell identity of the target PSCell, the MN may transmit at least one request to release at least one CHO preparing in the indicated target PSCells and/or inform the UE about at least one released PSCell.

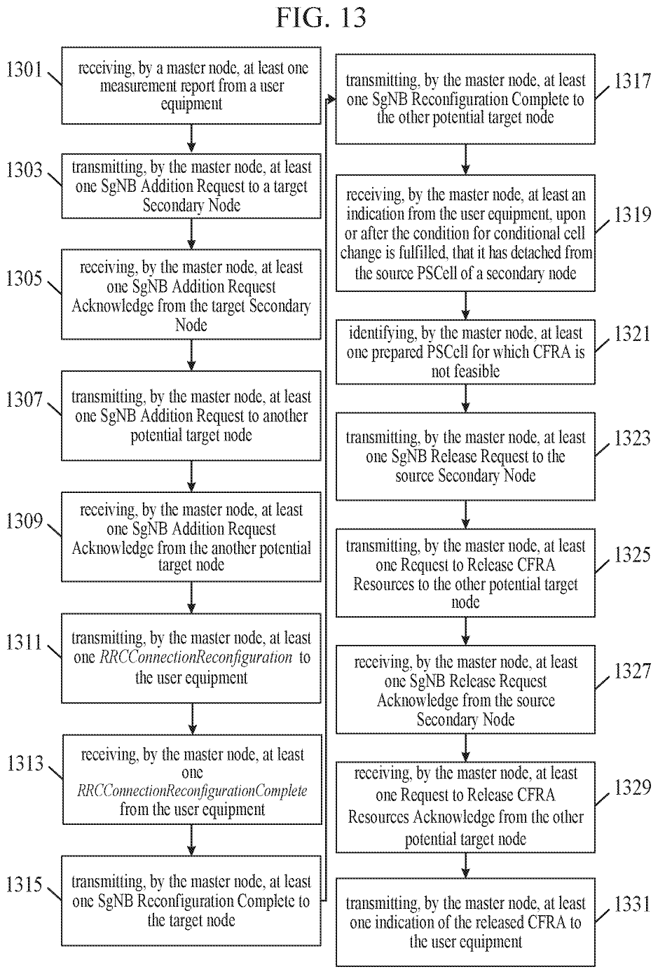

FIG. 13 illustrates an example of a method performed by a network entity, such as network entity 1420 illustrated in FIG. 14, according to certain embodiments. In step 1301, the NE may receive at least one measurement report from a user equipment. In step 1303, the NE may transmit at least one SgNB Addition Request to a target Secondary Node. In step 1305, the NE may receive at least one SgNB Addition Request Acknowledge from the target Secondary Node. In step 1307, the NE may transmit at least one SgNB Addition Request to another potential target node. In step 1309, the NE may receive at least one SgNB Addition Request Acknowledge from the other potential target node. In step 1311, the NE may transmit at least one RRCConnectionReconfiguration to the user equipment. In step 1313, the NE may receive at least one RRCConnectionReconfigurationComplete from the user equipment.

In step 1315, the NE may transmit at least one SgNB Reconfiguration Complete to the target node. In step 1317, the NE may transmit at least one SgNB Reconfiguration Complete to the other potential target node. In step 1319, the NE may receive at least an indication from the user equipment, upon or after the condition for conditional cell change is fulfilled, that it has detached from the source PSCell of a secondary node. The indication may further include information about the validity of CFRA resources of at least one prepared target PSCell. In step 1321, the NE may identify at least one prepared PSCell for which CFRA is not feasible. In step 1323, the NE may transmit at least one SgNB Release Request to the source Secondary Node. In step 1325, the NE may transmit at least one Request to Release CFRA Resources to the other potential target node. In step 1327, the NE may receive at least one SgNB Release Request Acknowledge from the source Secondary Node. In step 1329, the NE may receive at least one Request to Release CFRA Resources Acknowledge from the other potential target node. In step 1331, the NE may transmit at least one indication of the released CFRA to the user equipment.

FIG. 14 illustrates an example of a system according to certain embodiments. In one embodiment, a system may include multiple devices, such as, for example, user equipment 1410 and/or network entity 1420.

User equipment 1410 may include one or more of a mobile device, such as a mobile phone, smart phone, personal digital assistant (PDA), tablet, or portable media player, digital camera, pocket video camera, video game console, navigation unit, such as a global positioning system (GPS) device, desktop or laptop computer, single-location device, such as a sensor or smart meter, or any combination thereof.

Network entity 1420 may be one or more of: a base station, such as an evolved node B (eNB) or 5G or New Radio node B (gNB), a serving gateway, a server, and/or any other access node or combination thereof. Network entity 1420 may also be similar to user equipment 1410. Furthermore, network entity 1420 and/or user equipment 1410 may be one or more of a citizens broadband radio service device (CBSD).

In addition, in some embodiments, functionality of the network entity 1420 and/or UE 1410 may be implemented by other network nodes, such as a wireless relay node. For example, functionalities of UE 1410 may be performed by a mobile termination (MT) component of the IAB node.

One or more of these devices may include at least one processor, respectively indicated as 1411 and 1421. Processors 1411 and 1421 may be embodied by any computational or data processing device, such as a central processing unit (CPU), application specific integrated circuit (ASIC), or comparable device. The processors may be implemented as a single controller, or a plurality of controllers or processors.

At least one memory may be provided in one or more of devices indicated at 1412 and 1422. The memory may be fixed or removable. The memory may include computer program instructions or computer code contained therein. Memories 1412 and 1422 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate from the one or more processors. Furthermore, the computer program instructions stored in the memory and which may be processed by the processors may be any suitable form of computer program code, for example, a compiled or interpreted computer program written in any suitable programming language. Memory may be removable or non-removable.

Processors 1411 and 1421 and memories 1412 and 1422 or a subset thereof, may be configured to provide means corresponding to the various blocks of FIGS. 1-13. Although not shown, the devices may also include positioning hardware, such as GPS or micro electrical mechanical system (MEMS) hardware, which may be used to determine a location of the device. Other sensors are also permitted and may be included to determine location, elevation, orientation, and so forth, such as barometers, compasses, and the like.

As shown in FIG. 14, transceivers 1413 and 1423 may be provided, and one or more devices may also include at least one antenna, respectively illustrated as 1414 and 1424. The device may have many antennas, such as an array of antennas configured for multiple input multiple output (MIMO) communications, or multiple antennas for multiple radio access technologies. Other configurations of these devices, for example, may be provided. Transceivers 1413 and 1423 may be a transmitter, a receiver, or both a transmitter and a receiver, or a unit or device that may be configured both for transmission and reception.

The memory and the computer program instructions may be configured, with the processor for the particular device, to cause a hardware apparatus such as user equipment to perform any of the processes described below (see, for example, FIGS. 1-13). Therefore, in certain embodiments, a non-transitory computer-readable medium may be encoded with computer instructions that, when executed in hardware, perform a process such as one of the processes described herein. Alternatively, certain embodiments may be performed entirely in hardware.

In certain embodiments, an apparatus may include circuitry configured to perform any of the processes or functions illustrated in FIGS. 1-13. For example, circuitry may be hardware-only circuit implementations, such as analog and/or digital circuitry. In another example, circuitry may be a combination of hardware circuits and software, such as a combination of analog and/or digital hardware circuit(s) with software or firmware, and/or any portions of hardware processor(s) with software (including digital signal processor(s)), software, and at least one memory that work together to cause an apparatus to perform various processes or functions. In yet another example, circuitry may be hardware circuit(s) and or processor(s), such as a microprocessor(s) or a portion of a microprocessor(s), that include software, such as firmware for operation. Software in circuitry may not be present when it is not needed for the operation of the hardware.

The features, structures, or characteristics of certain embodiments described throughout this specification may be combined in any suitable manner in one or more embodiments. For example, the usage of the phrases “certain embodiments,” “some embodiments,” “other embodiments,” or other similar language, throughout this specification refers to the fact that a particular feature, structure, or characteristic described in connection with the embodiment may be included in at least one embodiment of the present invention. Thus, appearance of the phrases “in certain embodiments,” “in some embodiments,” “in other embodiments,” or other similar language, throughout this specification does not necessarily refer to the same group of embodiments, and the described features, structures, or characteristics may be combined in any suitable manner in one or more embodiments.

One having ordinary skill in the art will readily understand that certain embodiments discussed above may be practiced with steps in a different order, and/or with hardware elements in configurations which are different than those which are disclosed. Therefore, it would be apparent to those of skill in the art that certain modifications, variations, and alternative constructions would be apparent, while remaining within the spirit and scope of the invention. In order to determine the metes and bounds of the invention, therefore, reference should be made to the appended claims.

### PARTIAL GLOSSARY

3GPP 3rd Generation Partnership Project
BS Base Station
CBRA Contention Based Random Access
CE Control Element
CFRA Contention Free Random Access
CHO Conditional Handover
C-RNTI Cell-Radio Network Temporary Identifier
CSI-RS Channel State Information Reference Signals
CU Centralized Unit
DCI Downlink Control Information
DL Downlink
DU Distributed Unit
eMBB Enhanced Mobile Broadband
eNB Evolved Node B
EN-DC E-UTRAN Dual Connectivity
EPS Evolved Packet System
E-UTRAN Evolved-Universal Mobile Telecommunications Serve Terrestrial Radio Access Network
gNB Next Generation Node B
GPS Global Positioning System
HO Handover
LTE Long-Term Evolution
MAC Medium Access Control
MN Master Node
NR New Radio
PBCH Physical Broadcast Channel
PSCell Primary Secondary Cell
PUCCH Physical Uplink Control Channel
RACH Random Access Channel
RAN Radio Access Network
RAR Random Access Response
RAT Radio Access Technology
RRM Radio Resource Management
RS Reference Signal
RSRP Reference Signals Received Power
RSRQ Reference Signal Received Quality
RX Reception
SIB System Information Block
SINR Signal to Interference & Noise Ratio
SMTC Synchronization Signal/Physical Broadcast Channel Block Measurement Time Configuration
SN Secondary Node
SSB Synchronization Signal Block
TCI Transmission Configuration Indication
TS Technical Specification
TX Transmission
UE User Equipment
UL Uplink
URLLC Ultra-Reliable and Low-Latency Communication
WLAN Wireless Local Area Network

1-30. (canceled)

31. An apparatus, comprising:
at least one processor; and
at least one memory including computer program code,
wherein the at least one memory and the computer program code are configured to, with the at least one processor, cause the apparatus at least to:
receive at least one indication from a user equipment upon or after at least one condition for conditional cell change is fulfilled that the user equipment has detached from at least one source primary secondary cell, PSCell, of a source secondary node.

32. The apparatus of claim 31, wherein the at least one memory and the computer program code are further configured to, with the at least one processor, cause the apparatus at least to:
transmit at least one secondary next generation node B, SgNB, release request to the source secondary node such that the secondary node at least one of stops transmission and reception on the source PSCell, or initiates data forwarding to a target secondary node or to the apparatus.

33. The apparatus of claim 31, wherein the at least one memory and the computer program code are further configured to, with the at least one processor, cause the apparatus at least to:
receive at least one SgNB release request acknowledge from the source secondary node.

34. The apparatus of claim 31, wherein the at least one memory and the computer program code are further configured to, with the at least one processor, cause the apparatus at least to:
receive at least one sequence number status transfer indication from the secondary source node.

35. The apparatus of claim 34, wherein the at least one memory and the computer program code are further configured to, with the at least one processor, cause the apparatus at least to:
transmit the at least one sequence number status transfer indication to the target secondary node.

36. The apparatus of claim 32, wherein the at least one memory and the computer program code are further configured to, with the at least one processor, cause the apparatus at least to:
forward user data to the target secondary node upon receiving the at least one indication from the user equipment.

37. The apparatus of claim 31, wherein the at least one indication is received over at least one physical uplink control channel, at least one medium access control control element, or at least one radio resource control message.

38. A method, comprising:
receiving by a master node involved in multi-connectivity, at least one indication from a user equipment upon or after at least one condition for conditional cell change is fulfilled that the user equipment has detached from at least one source primary secondary cell, PSCell, of a source secondary node.

39. The method of claim 38, further comprising:
transmitting by the master node, at least one secondary next generation node B, SgNB, release request to the source secondary node such that the secondary node at least one of stops transmission and reception on the source PSCell, or initiates data forwarding to a target secondary node or to the master node.

40. The method of claim 38, further comprising:
receiving by the master node, at least one SgNB release request acknowledge from the source secondary node.

41. The method of claim 38, further comprising:
receiving by the master node, at least one sequence number status transfer indication from the secondary source node.

42. The method of claim 41, further comprising:
transmitting by the master node, the at least one sequence number status transfer indication to the target secondary node.

43. The method of claim 39, further comprising:
forwarding by the master node, user data to the target secondary node upon receiving the at least one indication from the user equipment.

44. The method of claim 38, wherein the at least one indication is received over at least one physical uplink control channel, at least one medium access control control element, or at least one radio resource control message.

45. An apparatus, comprising:
at least one processor; and
at least one memory including computer program code,
wherein the at least one memory and the computer program code are configured to, with the at least one processor, cause the apparatus at least to:
transmit at least one indication to a master node upon or after at least one condition for conditional cell change is fulfilled that the apparatus has detached from at least one source primary secondary cell of a source secondary node.

46. A method, comprising:
transmitting by a user equipment involved in multi-connectivity, at least one indication to a master node upon or after at least one condition for conditional cell change is fulfilled that the user equipment has detached from at least one source primary secondary cell of a source secondary node.

47. A non-transitory computer-readable medium storing program code which, when the program code is executed by at least one processor, causes the at least one processor to perform receiving by a master node involved in multi-connectivity, at least one indication from a user equipment upon or after at least one condition for conditional cell change is fulfilled that the user equipment has detached from at least one source primary secondary cell of a source secondary node.

48. A non-transitory computer-readable medium storing program code which, when the program code is executed by at least one processor, causes the at least one processor to perform transmitting by a user equipment involved in multi-connectivity, at least one indication to a master node upon or after at least one condition for conditional cell change is fulfilled that the user equipment has detached from at least one source primary secondary cell of a source secondary node.
